(19) United States
(12) Patent Application Publication
(10) Pub. No.: US 2002/0154096 A1
(43) Pub. Date: Oct. 24, 2002

(54) Multi-functional keyboard for notebook type computer

(76) Inventor: Ching-Hsiu Chou, Taipei Hsien (TW)

Correspondence Address: BACON & THOMAS, PLLC, 4TH Floor, 625 Slaters Lane, Alexandria, VA, 22314-1176, US

(21) Appl. No.: 09/837,462

(22) Filed: Apr. 19, 2001

(51) Int. Cl. G09G 5/00

(52) U.S. Cl. 345/168; 345/171

(57) ABSTRACT

In a multi-functional keyboard for notebook type computer, three functional keys [GA], [G5] and [G6] plus 17 entry keys are added so as to combine 47 entry key mode and 64 entry key mode together in one keyboard enabling the computer to be applicable for both western phonetical character and eastern hieroglyphic character. By utilizing three functional keys [GA], [G5] and [G6], the computer is able to rapidly connect to/disconnect from the internet, convert characters between different types for different countries, and convert operation mode (for example, from 47 to 64 keys). Moreover, the configuration of character or word forms stored in the data track of the computer representing individual countries can be printed on the key surfaces for facilitating operation.

### BACKGROUND OF THE INVENTION

1. Field of the Invention

The present invention relates to multi-functional keyboard for notebook type computer, and more particularly, to a keyboard in which three functional keys [GA],[G5] and [G6] and 17 entry keys are added so that 47 entry key mode and 64 entry key mode are combined together in one keyboard for a notebook type computer enabling the computer to exhibit multi-function.

2. Description of the Prior Art

On the present market of notebook type computer, the most popularly used one is a type composing 47 entry keys which is only available for English. Due to insufficient number of keys, this computer is inapplicable for using in those countries where hieroglyphics or Latin characters are used.

To meet needs of different countries, manufacturers must prepare several keyboards of different specification which brings about confusion to their production lines. Aiming at the above depicted shortcoming, the present inventor, who is well experienced in manufacturing the notebook type computer has delved into this matter with a long time efforts and come to realization of the present invention.

### SUMMARY OF THE INVENTION

It is an object of the present invention to provide a multi-functional keyboard for notebook type computer in which three functional keys [GA],[G5] and [G6] and 17 entry keys are added so that 47 entry key mode and 64 entry key mode are combined together in one keyboard for a notebook type computer.

In the present invention, [GA] key is for enabling the computer to achieve rapid connection to/disconnection from the internet.

In the present invention, [G5] key is for rapid conversion of characters between different types used by different countries.

In the present invention, [G6] key is for rapid conversion of operation mode of the keyboard from 47 entry key mode to 64 entry key mode.

The dexterous feature of the present invention is achieved by participation of three functional keys [GA],[G5] and [G6] and 17 entry keys to the conventional keyboard so that this keyboard is offered multi-functions to be applicable for different kinds of languages and characters. If the added 17 keys are incorporated in the 47 entry key mode e.g. English mode, the figures and symbols can be expressed thereby. If the added 17 keys are incorporated in the 64 entry key mode, e.g. Latin or hieroglyphics mode, they can be used to input corresponding characters.

### BRIEF DESCRIPTION OF THE DRAWINGS

For fuller understanding the nature and objects of the invention, reference should be made to the following detailed description taken in conjunction with the accompanying drawings in which:

FIG. 1 is a schematic view of the present invention prepared for English mode usable for entry of English characters;

FIG. 2 is a schematic view of the present invention prepared for Latin mode usable for entry of Latin characters; and

FIG. 3 is a schematic view of the present invention prepared for hieroglyphic mode usable for entry of hieroglyphic characters.

### DETAILED DESCRIPTION OF THE PREFERRED EMBODIMENT

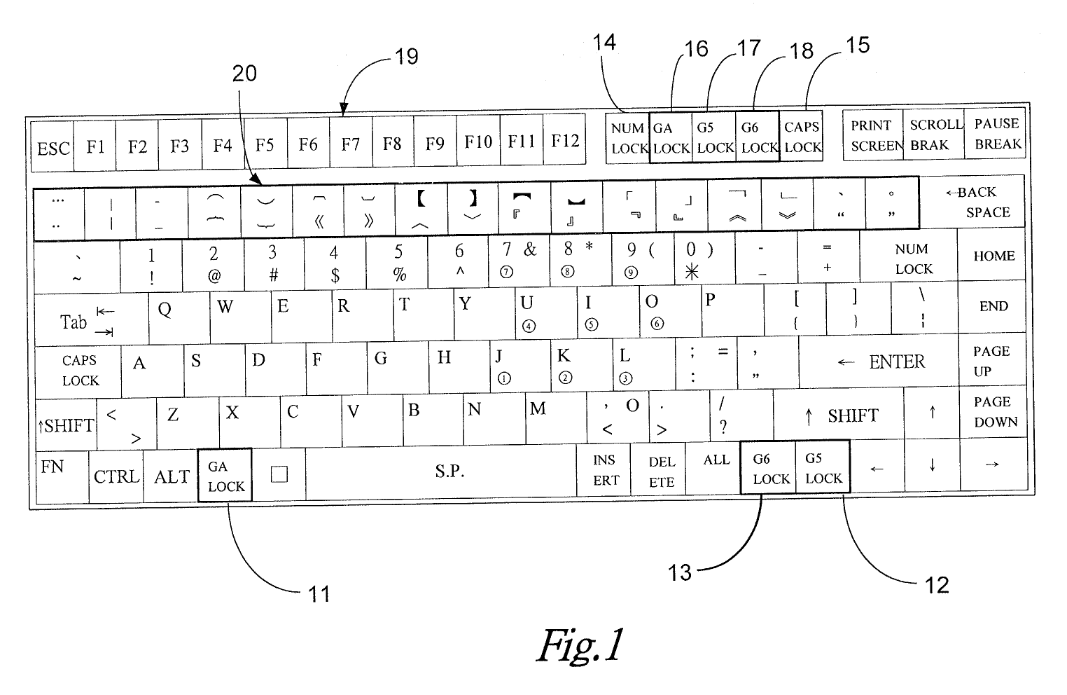

For operating the present invention in English mode, reference should be made to FIG. 1. As shown in FIG. 1, three functional keys 11, 12, 13 marled [GA Lock], [G5 Lock], and [G6 Lock] respectively are added in the lowermost array of a conventional keyboard, and three pilot lamps 16, 17, 18 for three functional keys [GA Lock], [G5 Lock], and [G6 Lock] are provided respectively between a pilot lamp 14 for the Num Lock key and pilot lamp 15 for the Caps Lock key such that when any one of the functional keys is pressed, the corresponding pilot lamp is turned on. Further to this, 17 symbol entry keys 20 are added under F class functional key 19, namely F1, F2, F3 . . . F12. The functional key 11 [GA Lock] is for enabling the computer to achieve rapid connection to/disconnection from the internet. The [G5 Lock] function key 12 is for rapid conversion between characters of different types used by different countries, for example, from English mode using 47 keys to Latin mode using 64 keys, or to hieroglyphic mode using 64 keys. As for [G6 Lock] functional key 13 is for rapid conversion of operation mode of the keyboard from 47 entry key mode to 64 entry key mode.

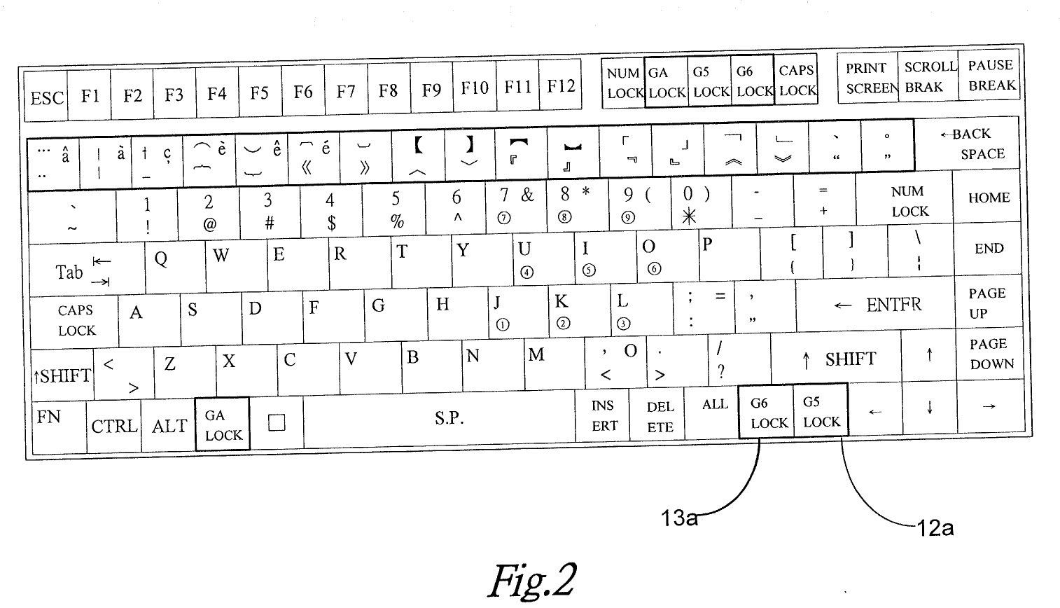

For operating the present invention in Latin mode, reference should be made to FIG. 2. Assuming that the keyboard is originally in English mode, at first by pressing [G6] functional key 13a so as to convert 47 key operation mode into 64 key operation mode, then by pressing [G5] functional key 12a to convert English mode into Latin mode, and those 17 symbol entry keys 20 in English mode are also converted into Latin mode.

The keyboard in operation mode of 64 entry keys can also be converted into operation mode of any Latin languages, for example, it is converted to French by pressing [G5] and F, converted to German by pressing [G5] and G, and converted to Portuguese by pressing [G5] and P.

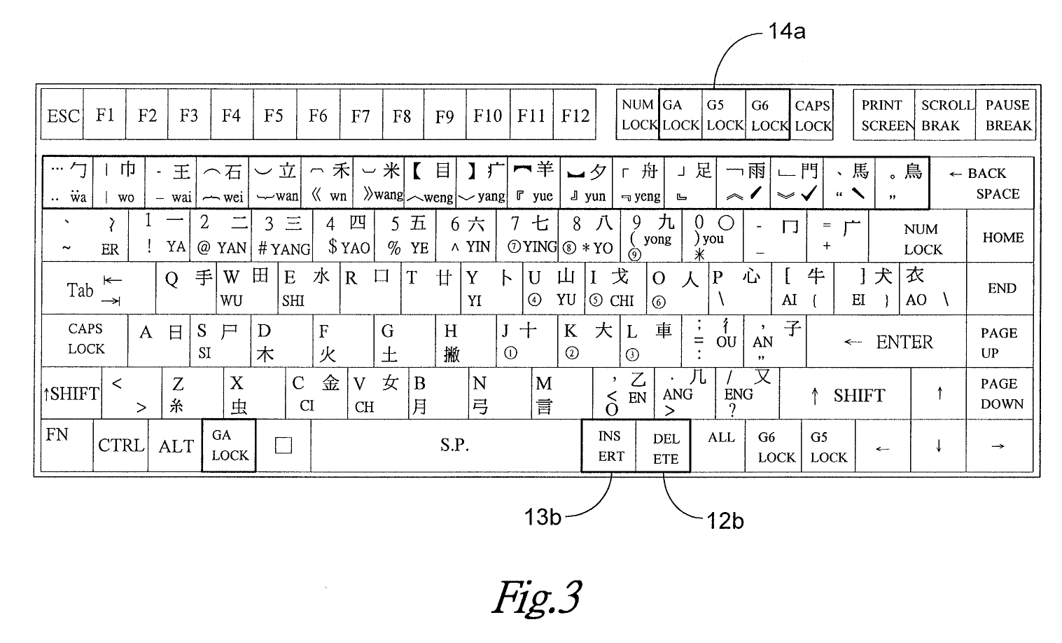

For operating the present invention in hieroglyphic mode, reference should be made to FIG. 3. As shown in FIG. 3, assuming that the keyboard is originally in English mode, at first by pressing [G6] functional key 136 so as to convert 47 key operation mode into 64 key operation mode, then by pressing [G5] functional key 126 and the nation code to convert English mode into hieroglyphic mode of designated country, and those 17 symbol entry keys 20 in English mode are also converted into 17 symbol entry keys 20 in hieroglyphic mode.

The keyboard in operation mode of 64 entry keys can also be converted into operation mode of any country's hieroglyphic characters. For example, it can be converted from Chinese mode into Korean mode by pressing [G5] and K, converted to Japanese mode by pressing [G5] and J, and converted to Arabic mode by pressing [G5] and A. Conversion of orthodox Chinese character into simplified Chinese character can be carried out by pressing [G5] and GB, or converted reversely by pressing [G5] and BG.

In the present invention, the configuration of character or word forms stored in the data track of the computer representing individual countries can be printed on the key surfaces for the convenience of operation.

It emerges from the description of the above example that the invention has several noteworthy advantages in particular:

1. By adding three functional keys [GA], [G5] and [G6] plus 17 entry keys so as to combine 47 entry key mode and 64 entry key mode together in one keyboard enabling the computer to be applicable for both western phonetical character and eastern hieroglyphic character.

2. By utilizing three functional keys [GA], [G5] and [G6], the computer can be rapidly connected to/disconnected from the internet, convert characters between different types for different countries, and convert operation mode (for example, from 47 to 64 keys).

3. The configuration of character or word forms stored in the data track of the computer representing individual countries can be printed on the keys.

It is therefore to be understood that the above and other modifications and change may be readily made in the construction and arrangement of elements comprising the preferred and modified forms of invention without departing from the spirit and scope of the invention as defined by the appended claims and resonable equivalents thereof.

What is claimed is:

1. Multi-functional keyboard for notebook type computer characterized in that by adding three functional keys [GA], [G5], [G6] and 17 entry keys, 47 entry key mode and 64 entry key mode being combined together in one keyboard so as to enable said computer to rapidly connect to/disconnect from the internet, convert characters between different types for different countries, and convert operation mode.

2. The multi-functional keyboard of claim 1, wherein said 17 entry keys are utilized as entry keys for inputting symbols when in operation mode of 47 keys.

3. The multi-functional keyboard of claim 1, wherein said 17 entry keys are utilized as entry keys for inputting characters (words) when in operation mode of 64 keys.

4. The multi-functional keyboard of claim 1, wherein names of said three multi-functional keys [GA], [G5] and [G6] can be changed in case of need without effecting their usage.

5. The multi-functional keyboard of claim 1, wherein the configuration of character or word forms stored in the data track of the computer representing individual countries can be printed on said key surfaces for the convenience of operation.
